(19) United States
(12) Patent Application Publication
(10) Pub. No.: US 2025/0282475 A1
(43) Pub. Date: Sep. 11, 2025

(54) LOCKING DEVICE FOR MOVABLE COMPONENTS, IN PARTICULAR AIRCRAFT COMPONENTS SUCH AS AN AIRCRAFT LANDING GEAR

(71) Applicant: Liebherr-Aerospace Lindenberg GmbH, Lindenberg (DE)

(72) Inventors: Marcelo NASCIMENTO DUVAL, Sigmarszell (DE); Matthias PALT, Oberreute (DE); Teresa ARNUSCH, Heimenkirch (DE)

(21) Appl. No.: 19/070,364

(22) Filed: Mar. 4, 2025

(30) Foreign Application Priority Data
Mar. 6, 2024 (DE) 10 2024 106 478.1

(51) Int. Cl. B64C 25/26

(52) U.S. Cl. CPC B64C 25/26

(57) ABSTRACT

The disclosure proposes a locking device for movable components, in particular aircraft components such as an aircraft landing gear, which comprises a hook rotatable about an axis of rotation for receiving a pin portion fixedly arranged on the landing gear, wherein the hook has a U-shaped, C-shaped or V-shaped opening, which is designed receive the pin portion in a locked state in a first rotational position and to release the pin portion in an unlocked state in a second rotational position. The disclosure is characterised in that at least one of the two legs of the U-shaped, C-shaped or V-shaped opening has a non-constant contour in the width direction.

### CROSS REFERENCE TO RELATED APPLICATION

The present application claims priority to German Patent Application No. 10 2024106 478.1 filed on Mar. 6, 2024. The entire contents of the above-listed application are hereby incorporated by reference for all purposes.

### TECHNICAL FIELD

The present disclosure relates to a locking device for movable components, in particular aircraft components such as an aircraft landing gear or similar.

### BACKGROUND

Locking elements play a central role in the safety and functionality of a large number of applications, as they can ensure that a movable component does not accidentally come loose and cause damage. This is particularly important for aircraft components, in particular for critical systems such as the aircraft landing gear, as it must be ensured that moving parts are securely fixed during flight operations but can be released with a high degree of reliability if required by the operating conditions.

### SUMMARY

If we take the retractable landing gear of an aircraft as an example of a moving component, we immediately realise that the design, locking and safe release of this component are of the utmost importance, as they directly affect safety during flight and landing. The conventional locking mechanisms for retractable landing gear known from the prior art are based on a ‘hook and pin’ solution and have by and large proven their worth, but have significant disadvantages that can affect performance and safety.

In the conventional embodiment, the landing gear is secured in the retracted position by a rotating hook, which is part of the aircraft structure, and a pin permanently mounted on the landing gear. The upward movement of the pin in the hook, caused by the retraction of the aircraft landing gear, causes the system to close and partially lock. Although this principle works on a basic level, specific prerequisites are required for it to function correctly, such as the exact positioning and alignment of the pin within the hook to prevent it from canting.

If the pin and hook are canted due to manufacturing tolerances or deformation of a component, it may not be possible to release the locked landing gear as required.

The precision of the interaction between the different components is challenging and difficult to realise due to manufacturing tolerances and potential deformations, so there is always a residual risk of canting.

Previous solutions to avoid canting, which aim to increase the distance between the pin holder and the hook or to enlarge the hook opening, lead to a disadvantageous design that results in oversizing, increased loads on the pin, increased weight and unnecessarily large play between the locking components. This can adversely affect the performance and costs of the locking device, since, for example, excessive play between the hook receptacle and the pin arranged in the receptacle leads to undesired movement and very high wear if the pin strikes the receptacle.

The present disclosure succeeds in overcoming or at least mitigating the above-mentioned problems.

According to the disclosure, an embodiment proposes an optimised design of the U-shaped, V-shaped or C-shaped receptacle for gripping around the pin portion, which reduces the tolerance requirements and/or reduces the likelihood of canting. This increases the efficiency and reliability of the locking. The embodiment thus includes a locking device, which is advantageous over the implementation known from the prior art, as it is not only easier to produce and maintain, but also offers more robust performance under a wide range of operating conditions.

The disclosure relates to a locking device for movable components, in particular aircraft components such as an aircraft landing gear, which comprises a hook rotatable about an axis of rotation for receiving a pin portion fixedly arranged on the landing gear, wherein the hook has a U-shaped, V-shaped or C-shaped opening, which is designed receive the pin portion in a locked state in a first rotational position and to release the pin portion in an unlocked state in a second rotational position. The locking device is characterised in that at least one of the two legs of the U-shaped, V-shaped or C-shaped opening has a non-constant contour in the width direction.

As one or both of the legs have a non-constant contour in their width direction, the pin portion received in the U-shaped, V-shaped or C-shaped opening is much less likely to cant if it is tilted.

Locking devices known from the prior art have legs that have a continuous straight contour in their width direction. The disadvantage of this is that if a pin portion is inserted at an angle into the U-shaped opening formed by the legs, said legs of this opening being straight in the width direction, there is a high probability of tilting, so that the functionality of locking or releasing using the locking device is no longer ensured.

This is precisely where the present disclosure comes in and proposes a U-shaped, V-shaped or C-shaped opening in which at least one of the two legs is not constant in its width direction. This can reduce the likelihood of canting when the pin portion is inserted at an angle into the U-shaped, V-shaped or C-shaped opening.

According to an optional development of the present disclosure, it can be provided that the non-constant contour of at least one of the two legs of the U-shaped, V-shaped or C-shaped opening is convex in the width direction, optionally by providing a spherical structure.

By providing a convex structure that extends from at least one of the two legs in the direction of the other leg, an advantageous design is provided in the formation of the leg. Finally, compared to a straight contour of the leg, there is greater scope for the pin to rotate in relation to the width direction without it coming into contact with a correspondingly convex leg and without the risk of canting.

The convex structure rises into the receiving space formed by the U-shaped, V-shaped or C-shaped opening and runs in its convex form in the width direction of the locking device.

According to an advantageous modification of the present disclosure, it can further be provided that the non-constant contour of at least one of the two legs of the U-shaped, V-shaped or C-shaped opening is designed in the width direction in such a way that it has a maximum extension towards the opposite leg in its centre as seen in the width direction, optionally wherein the extension decreases continuously or discontinuously from the centre seen in the width direction to each of the two edge regions.

By forming the maximum extension of a leg in its centre as seen in the width direction, the probability of canting with a pin portion inserted into the U-shaped, V-shaped, or C-shaped opening, the longitudinal axis of which runs parallel to the wide axis, is further reduced.

According to the disclosure, it can further be provided that the two legs have an identical contour when viewed in the width direction, optionally over their respective lengths or a length portion, optionally wherein the length of a respective leg extends from the associated web portion to a distal end of the leg.

It is advantageous if the two legs defining the U-shaped, V-shaped or C-shaped opening are identical in their contour running in the width direction.

According to an optional modification of the present disclosure, it can be provided that the two legs have a different contour when viewed in the width direction, optionally wherein the length of a respective leg extends from the associated web portion to a distal end of the leg.

However, the disclosure also includes the case wherein the two legs defining the U-shaped, V-shaped or C-shaped opening are designed differently in their contour running in the width direction. This can have advantages with regard to the manufacture of the locking device and the guiding behaviour when the web portion is inserted into the U-shaped, V-shaped or C-shaped opening. This ensures, for example, that a rotated web portion is forced back into its original orientation by contact with a contour of a leg running in the width direction, but that there is no risk of canting due to the non-identical design of the other leg.

According to an optional development of the present disclosure, it can further be provided that the width direction is parallel to the axis of rotation of the hook and/or the respective contour of the legs of the U-shaped, V-shaped or C-shaped opening are those surfaces that face each other and between which the pin portion is guided to take up a locked position.

Furthermore, according to an advantageous embodiment of the present disclosure, it can be provided that the two legs of the U-shaped, V-shaped or C-shaped opening run parallel to each other in their longitudinal direction.

According to an advantageous development of the present disclosure, it can be provided that the U-shaped, V-shaped or C-shaped opening comprises or consists of two substantially straight legs and a curved web portion connecting the two legs to one another.

It can further be provided according to the disclosure that the U-shaped, V-shaped or C-shaped opening has two legs of different lengths.

Providing legs of different lengths can be advantageous in particular because the hook can also be rotated by inserting the pin portion into the U-shaped, V-shaped or C-shaped opening. It is helpful if the two legs forming the U-shaped, V-shaped or C-shaped opening are of different lengths.

According to a further advantageous modification of the present disclosure, it can be provided that the U-shaped, V-shaped or C-shaped opening is formed in a view on a plane, the normal of which is parallel to the axis of rotation of the hook.

The disclosure also relates to a system consisting of a locking device and a movable component, in particular an aircraft component such as an aircraft landing gear, wherein the locking device is designed according to any one of the aspects discussed, optionally wherein the movable component is an aircraft component, in particular a retractable aircraft landing gear, a door, a landing flap or a wing tip, which can be locked in a retracted/folded state by the locking device.

It can further be provided that the axis of rotation of the hook is arranged parallel to the longitudinal axis of the pin portion, for example in the error-free/non-inclined case, wherein optionally a deviation of the parallelism from the axis of rotation of the hook to the longitudinal axis of the pin portion represents an undesirable condition. This does not only apply to the error-free case. This means that parallelism cannot be guaranteed even in the event of manufacturing tolerances or deformation (if the aircraft or wing deforms).

As already mentioned at the outset, canting of the longitudinal axis of the pin portion can lead to tilting in the U-shaped, V-shaped or C-shaped opening of the hook. It is therefore a condition that deviates from the optimum case if the axis of rotation of the hook is not aligned parallel to the longitudinal axis of the pin portion.

According to a further optional development of the present disclosure, it can be provided that the pin portion is attached at one or both end regions to a mounting of the movable component or is an integral part thereof.

The pin portion can therefore be firmly connected to a holder at both of its end regions or is designed integrally with the holder. Accordingly, the pin portion does not have a free end, but merges directly into the holder at each of its two ends in the longitudinal direction or is attached to it there.

According to a further advantageous embodiment of the present disclosure, it can be provided that the hook is gripped around the pin portion in a region that is formed approximately in the centre, optionally in the central third of the longitudinal extent of the pin portion, more optionally in the central fifth, between the holders of the pin portion provided at the end regions.

The engagement of the U-shaped, V-shaped or C-shaped opening of the hook in a central region of the pin portion ensures a particularly low probability of canting, as the regions of the holder provided at the end regions of the pin portion then typically do not collide with the legs of the U-shaped, V-shaped or C-shaped opening. However, this is more likely to occur if the engagement region of the U-shaped, V-shaped or C-shaped opening of the hook is not centred along the length of the pin portion or centred in relation to the holders for the pin portion.

The disclosure also relates to an aircraft having a locking device according to any one of the aspects previously discussed or a system according to any one of the aspects previously discussed.

According to this development, for example, the retractable landing gear can be rotatably arranged on the structure of the aircraft such that it can change between an extended and a retracted position.

### BRIEF DESCRIPTION OF THE FIGURES

Further features, details and advantages of the disclosure can be seen in the following description of the figures. In the figures:

FIG. 1: shows a sectional view of the locking device according to the disclosure having a pin portion to be inserted into the U-shaped opening,

FIG. 2 shows a representation of a pin portion canted in the U-shaped opening in a locking device according to the prior art,

FIG. 3: shows a representation of an embodiment of the locking device according to the disclosure together with a pin portion arranged in the U-shaped opening,

FIG. 4: shows a representation of a further embodiment of the locking device according to the disclosure together with a pin portion arranged in the U-shaped opening,

FIG. 5: shows a representation of a further embodiment of the locking device according to the disclosure together with a pin portion arranged in the U-shaped opening,

FIG. 6: shows a representation of a further embodiment of the locking device according to the disclosure together with a pin portion arranged in the U-shaped opening,

FIG. 7: shows a representation of a further embodiment of the locking device according to the disclosure together with a pin portion arranged in the U-shaped opening, and

FIG. 8: shows a representation of a further embodiment of the locking device according to the disclosure together with a pin portion arranged in the U-shaped opening.

### DETAILED DESCRIPTION

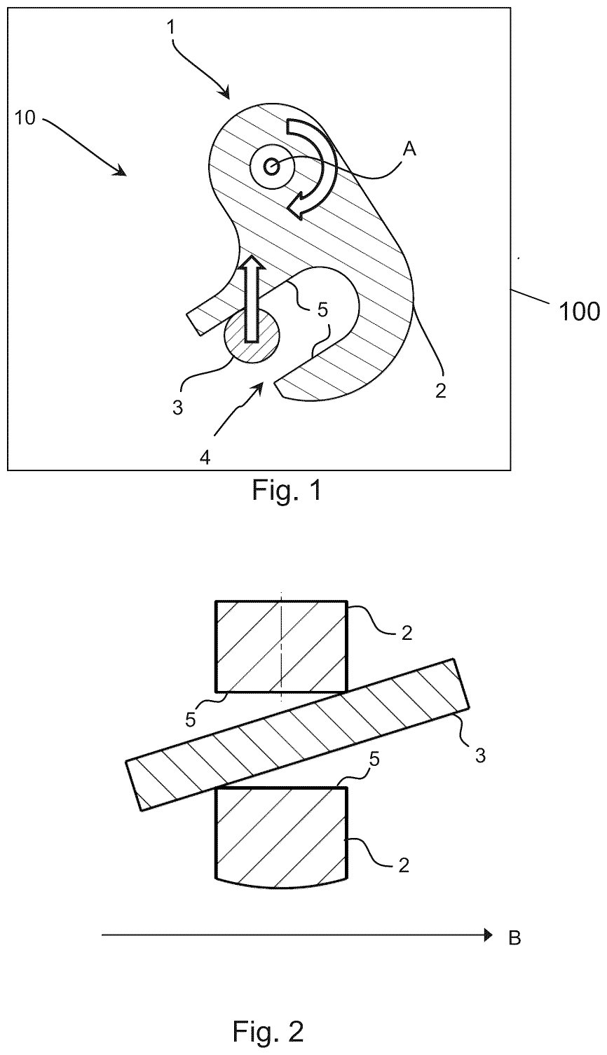

FIG. 1 shows a sectional view of the locking device 1 according to the disclosure having a pin portion 3 to be inserted into the U-shaped opening 4. FIG. 1 shows the locking device may be of a component of an aircraft 100, such as a landing gear or other element as noted herein.

The exemplary embodiment applies accordingly to V-shaped or C-shaped openings.

The locking device 1 comprises a hook 2 that can be rotated about an axis of rotation A. The rotation is represented by a curved arrow in FIG. 1 and indicates the various rotational positions that the hook 2 can assume.

In addition, a pin portion 3 with a circular cross-section can be seen, the direction of movement of which is characterised by a straight arrow. Exercising this straight movement causes the hook 2 to rotate about its axis of rotation A, so that the pin portion 3 can be locked by the hook 2 once the movement of the pin portion has been completed. For example, the hook 2 is rotatably attached to an aircraft structure and the pin portion 3 is fixed to a simple landing gear of an aircraft. The upward movement of the pin portion 3, which is fixed to the landing gear, into the hook 2, as shown by the straight arrow, causes the hook to close and assume the lockable position, which is then secured.

FIG. 2 shows a canting of the pin portion 3 in the U-shaped opening 4. The representation in FIG. 2 has been selected so as to show into the U-shaped opening here. As the pin portion 3 is inclined with respect to the axis of rotation A of the hook 2, a sticking contact may occur between the legs 5 of the U-shaped opening 4 and the outer contour of the pin portion 3.

It is clear to a person skilled in the art that the dimensions shown in the figures are in some cases greatly simplified for illustrative purposes and are shown with significantly more play than actually exists.

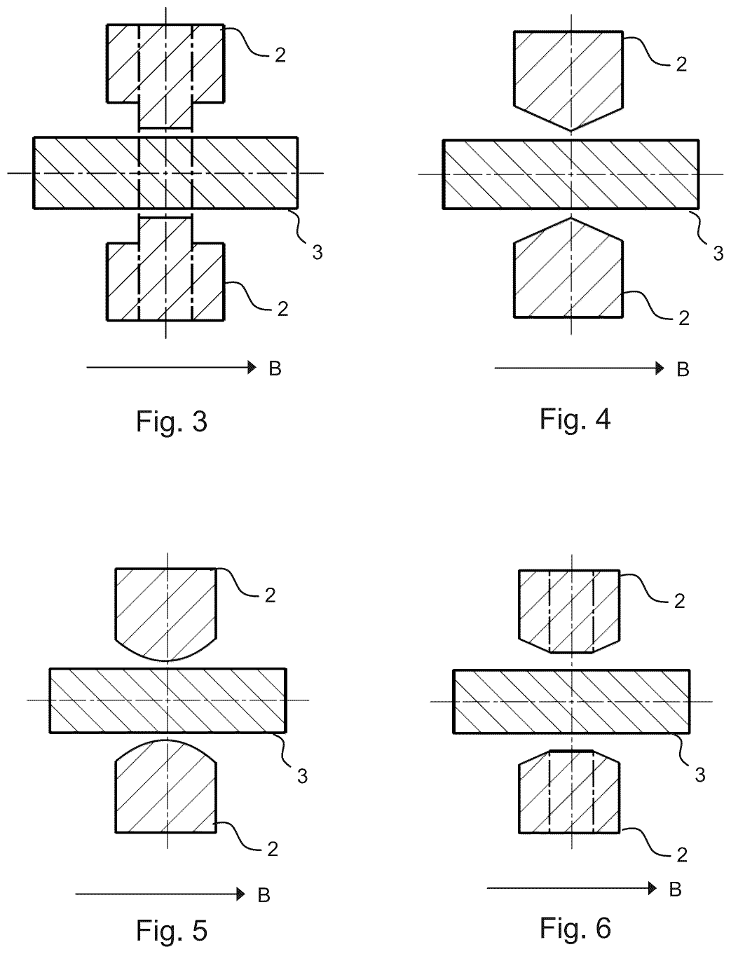

FIG. 3 shows, in a view similar to FIG. 2, an embodiment of the present disclosure in which the contour of the legs 5 is not constant in the width direction. The width direction B is shown in FIG. 3 for ease of understanding and runs parallel to the axis of rotation A from FIG. 1.

It can be seen that the two legs 5, which define the U-shaped opening 4 together with the web portion connecting the two legs 5 (not shown in FIG. 3), have a convex contour that extends to its maximum towards the centre of the opening region. The number of steps selected here is not limiting for the present disclosure, since a person skilled in the art immediately understands that a larger number of steps also reflects the core idea of the disclosure.

FIG. 4 shows a further embodiment of the present disclosure in a view analogous to the preceding FIG. 3, in which the contour of each of the two legs extending in the width direction tapers to a point in the centre (viewed in the width direction). From one end portion, seen in the width direction, there is a straight inclination towards the centre, until this drops straight down again to the other end portion (seen in the width direction B).

According to such a design, the play for receiving the pin portion 3 is reduced and at the same time a possible rotation without contact with a leg is increased. The advantage of this is that, even if the longitudinal axis of the pin portion 3 is twisted undesirably relative to the U-shaped opening 4, contact with one of the two legs 5 does not occur until much later than would have been the case with the implementation according to FIG. 2, which is known from the prior art.

FIG. 5 shows a further embodiment of the present disclosure in a view analogous to the preceding FIG. 4, in which the contour of each of the two legs extending in the width direction is curved. The contour, which rises convexly towards the inside of the opening, is now continuously curved in the width direction, which results in significantly less stress on contact with the pin portion 3 to be received.

FIG. 6 shows a further embodiment of the present disclosure in a view analogous to the preceding FIG. 5, in which the contour of each of the two legs extending in the width direction is formed parallel to the width direction in its centre and sloping towards an outer section at each of the two outer sections. This convex design of the two legs 5 projecting into the opening of the U-shaped receptacle 4 also allows greater torsion than an implementation of the same width according to the known prior art.

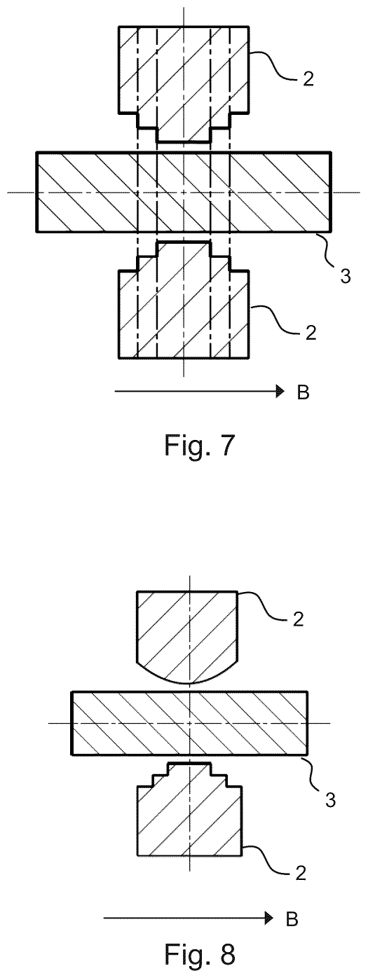

FIG. 7 shows a further embodiment of the present disclosure in a view analogous to the preceding FIG. 6, in which the contour extending in the width direction is spherical and comprises a plurality of steps. The central region (viewed in the width direction B) is also the region that protrudes furthest from the leg into the U-shaped opening 4 and drops down towards its left or right end portion.

FIG. 8 shows a further embodiment of the present disclosure in a view analogous to the preceding FIG. 7, in which the legs 5 facing each other are formed differently to each other. The leg shown at the top in FIG. 8 is designed according to FIG. 5, while the leg shown at the bottom in FIG. 8 is designed according to FIG. 7. The disclosure therefore also includes the fact that the two legs 5 can be formed differently from a common U-shaped opening 4.

### LIST OF REFERENCE NUMERALS

1 Locking device
2 Hook
3 Pin portion
4 U-shaped opening
5 Leg

1. Locking device for movable components, comprising:
a hook rotatable about an axis of rotation for receiving a pin portion fixedly arranged on the movable component, wherein
the hook has a U-shaped, V-shaped or C-shaped opening, which is designed receive the pin portion in a locked state in a first rotational position and to release the pin portion in an unlocked state in a second rotational position,
wherein
at least one of the two legs of the U-shaped opening has a non-constant contour in the width direction.

2. Device according to claim 1, wherein the non-constant contour of at least one of the two legs of the U-shaped, V-shaped or C-shaped opening is convex in the width direction.

3. Device according to claim 1, wherein the non-constant contour of at least one of the two legs of the U-shaped, V-shaped or C-shaped opening is designed in the width direction in such a way that it has a maximum extension towards the opposite leg in its centre as seen in the width direction.

4. Device according to claim 1, wherein the two legs have an identical contour when viewed in the width direction.

5. Device according to claim 1, wherein the two legs have a different contour when viewed in the width direction.

6. Device according to claim 1, wherein the width direction is parallel to the axis of rotation of the hook and/or the respective contour of the legs of the U-shaped, V-shaped or C-shaped opening are those surfaces that face each other and between which the pin portion is guided to take up a locked position.

7. Device according to claim 1, wherein the two legs of the U-shaped, V-shaped or C- shaped opening run parallel, at an angle or curved to each other in their longitudinal direction.

8. Device according to claim 1, wherein the U-shaped, V-shaped or C-shaped opening comprises or consists of two substantially straight or curved legs and a curved web portion connecting the two legs to one another.

9. Device according to claim 1, wherein the U-shaped, V-shaped or C-shaped opening has two legs of different lengths.

10. Device according to claim 1, wherein the U-shaped, V-shaped or C-shaped opening is formed in a sectional view along a plane, the normal of which is parallel to the axis of rotation of the hook.

11. System consisting of a locking device and a movable component, wherein the locking device is designed according to claim 1.

12. System according to claim 11, wherein the axis of rotation of the hook is arranged parallel to the longitudinal axis of the pin portion.

13. System according to claim 11, wherein the pin portion is attached at one or both end regions to a mounting of the movable component or is an integral part thereof.

14. System according to claim 13, wherein the hook is gripped around the pin portion in a region that is formed approximately in the centre.

15. Aircraft having a locking device according to claim 1.

16. Device according to claim 2, wherein the non-constant contour is convex in the width direction by providing a spherical structure.

17. Device according to claim 3, wherein the extension decreases continuously or discontinuously from the centre seen in the width direction to each of the two edge regions.

18. Device according to claim 4, wherein the length of a respective leg extends from the associated web portion to a distal end of the leg.

19. Device according to claim 5, wherein the length of a respective leg extends from the associated web portion to a distal end of the leg.

20. System according to claim 12, wherein a deviation of the parallelism from the axis of rotation of the hook to the longitudinal axis of the pin portion represents an undesirable condition.
